(19) United States
(12) Patent Application Publication
(10) Pub. No.: US 2024/0421631 A1
(43) Pub. Date: Dec. 19, 2024

(54) ELECTRICAL VEHICLE DETECTION FROM ELECTRIC INTERVAL DATA

(71) Applicant: Itron, Inc., Liberty Lake, WA (US)

(72) Inventors: Caelum Rodriguez, San Diego, CA (US); Yingjuan Du, San Diego, CA (US)

(21) Appl. No.: 18/209,419

(22) Filed: Jun. 13, 2023

(51) Int. Cl. H02J 13/00; H02J 3/00

(52) U.S. Cl. CPC H02J 13/00002; H02J 3/003; H02J 2203/20

(57) ABSTRACT

The disclosure describes three complimentary, synergistically interacting, and yet individually capable techniques for detecting electrical vehicle charging activities. In one example, convolutional neural network techniques find “edges” or points of significant change in electricity consumption. Time-series of electricity consumption are examined, and temperature is considered to normalize for changes in heating, ventilation, and air conditioning consumption. In an example, a time-series of electrical-consumption data of a service site is obtained over a time-range. The time-series of electrical-consumption data is converted into a time-series of consumption-change data. Temperature data may be associated with terms of the time-series of consumption-change data to thereby create input data for a machine-learned algorithm over the time-range. The input data is provided to a machine-learned model. The input data is processed over the time-range in the machine-learned model to generate output, such as a likelihood value of at least one EV charging event during the time-range.

### BACKGROUND

Electrical vehicles (EVs) are being purchased and driven at an accelerating rate. Level 2 EV chargers (approximately 3 to 19 kilowatts) are increasingly becoming available for residential installation. Many electrical utility grids struggle with the increased load associated with such charging. In this rapidly changing environment, electrical utility companies need a way to detect which customers are performing such charging, where they are located, and when the EV charging is happening in order to properly manage the electrical grid.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components. Moreover, the figures are intended to illustrate general concepts, and not to indicate required and/or necessary elements.

FIG. 1 is a block diagram showing an example electricity grid having example implementations of three techniques for detection of electrical vehicle (EV) charging events.

FIG. 2A is a block diagram showing an example configuration of the system(s) for detecting EV charging event(s).

FIG. 2B is a block diagram showing an example configuration of a convolutional neural network model.

FIG. 2C is a block diagram showing an example configuration of a midnight outlier model.

FIG. 2D is a block diagram showing an example configuration of a monolith shape model.

FIG. 2E is a graph showing an example time-series of consumption values and showing how consumption changes may or may not indicate EV charging events based on the monolith shape model.

FIG. 3 is a flow diagram showing example operation of a convolutional neural network model (and/or machine-learned model, and/or subroutine-implemented algorithm) utilized to detect EV charging.

FIG. 4 is a flow diagram showing an example technique for providing input to the model.

FIG. 5 is a flow diagram showing example techniques for processing data in the model to determine a likelihood of EV charging at a service site (e.g., a customer site).

FIG. 6 is a flow diagram showing example techniques for training a neural network or convolutional neural network.

FIG. 7 is a flow diagram showing additional example techniques for training a neural network or convolutional neural network.

FIG. 8 is a flow diagram showing example techniques used in response to detection of EV charging at a service site.

FIGS. 9A and 9B show a flow diagram illustrating example operation of a midnight outlier usage model utilized to detect EV charging.

FIG. 10 is a flow diagram showing an example technique for identifying outlier events having consumption values that are sufficiently large to indicate possible EV charging activity.

FIG. 11 is a flow diagram showing an example technique for processing, refining, and/or filtering the second outlier events to recognize third outlier events having a duration over a threshold.

FIG. 12 is a flow diagram showing an example technique for processing, refining, and/or filtering the third outlier events to recognize fourth outlier events.

FIG. 13 is a flow diagram showing an example technique for aggregating the fourth outlier events.

FIG. 14 is a flow diagram showing an example technique for deriving a time-series of changes in electricity consumption.

FIG. 15 is a flow diagram showing example operation of a monolithic shape model utilized to detect EV charging.

FIG. 16 is a flow diagram showing an example to recognize and/or evaluate consumption increases.

FIG. 17 is a flow diagram showing an example to recognize and/or evaluate consumption decreases.

### DETAILED DESCRIPTION

### Overview

The disclosure describes three complimentary, synergistically interacting, and yet individually capable techniques for detecting electric vehicle (EV) charging activities at a service site. In a first example, a convolutional neural network model finds “edges” or points of significant change in electricity consumption. Time-series of electricity consumption are examined, and temperature is considered to normalize for changes in heating, ventilation, and air conditioning (HVAC) consumption. In a second example, a midnight outlier usage model is based in part on research showing that the majority of EV charging events start during off-peak hours. In a third example, a monolithic shape model examines electricity consumption rates and looks for distinctive features that indicate EV charging behavior. Such EV charging events may look (if graphed) somewhat “monolith.”

Note that the “edges” or points of significant change in electricity consumption may be discovered by the machine-learned model. Such a model (e.g., a neural network) may be designed and/or trained in a way that is consistent (based on knowledge of best-techniques, academia, etc.) with being optimized to find these “edges” in data. Once the design is set and the model is trained, the machine-learned model becomes a black box or input/output machine, which recognizes EV charging events and distinguishes other events.

### Example System and Techniques

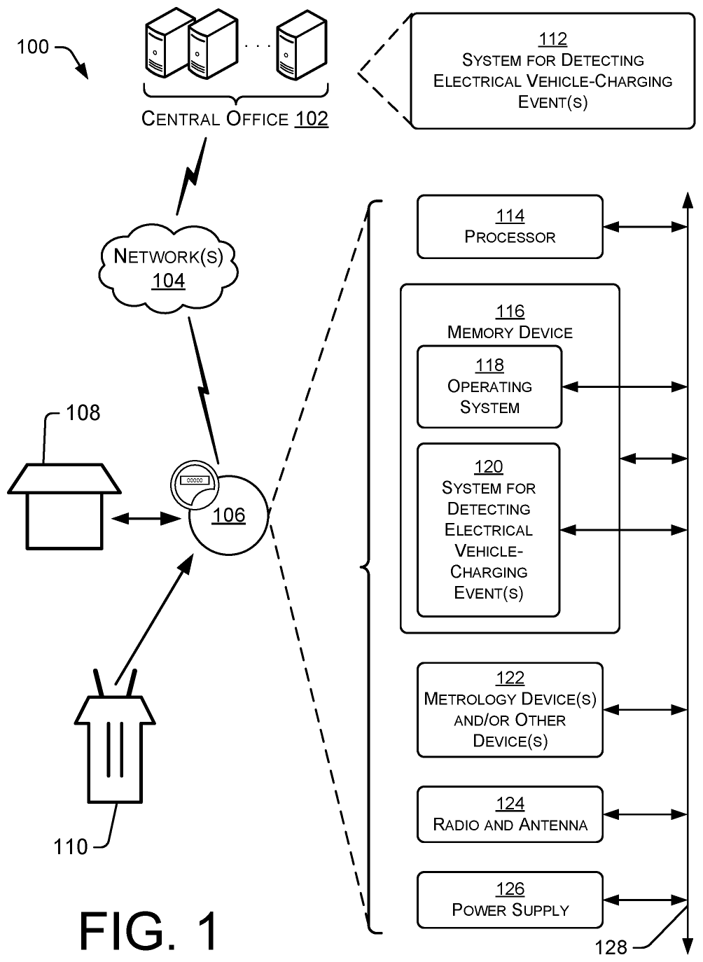

FIG. 1 shows an electricity grid 100 including three implementations of example techniques for detection of electrical vehicle-charging events. The electricity grid 100 may be configured to detect electrical vehicle-charging from electric interval data, and may be implemented either at the meter level, at the electricity company server level, and/or at the “cloud” level. The electricity grid 100 includes central office (e.g., cloud) computers and/or servers 102 and networks 104. The networks 104 may include one or more of the internet, utility company proprietary network(s) using radio, powerline communications (PLC), mesh networks, star networks, etc.

A utility meter 106 serves a customer site 108, and is representative of many such meters and sites, which may number in the thousands or hundreds of thousands within a service area. In the example shown, the meter is a smart meter and is in communication with the central office server(s) 102 through the network 104. A transformer 110 is configured to serve one or more customers, and provides low voltage service to the meter 106. The transformer 110 is representative of many such transformers, which may number in the thousands or hundreds of thousands.

A system for electrical vehicle detection from electric interval data may be located on the central office server 102, or on the smart utility meter 106. For purposes of illustration, FIG. 1 shows both examples, wherein the system 112 is located on the central office server 102, and wherein the system 120 is located on the smart utility meter 106. In some examples, the system 112 may include some of the functionality of an overall system, while the system 120 may include the remainder of the functionality. In an example, portions of the system operational on the servers 102 may calculate some aspects of the algorithms discussed herein, while portions of the system operational on the utility meter may perform other aspects of the algorithms.

In the example shown, the smart utility meter 106 includes a processor 114 and memory device 116. The memory device 116 may include software programs, that when executed by the processor 114, perform useful functions. In the example of FIG. 1, software applications are shown, including an operating system 118 and the system 120 for electrical vehicle detection.

The smart meter 106 may include metrology device(s) 122, which may measure electrical consumption. The metrology device(s) 122 may measure current flow and voltage levels. The measurements may be instantaneous power measurements (e.g., in Watts), or energy consumption over time (e.g., in kilowatt hours).

The measurements of the metrology devices(s) 122 may be configured as a time-series of voltage-measurements and current-measurements. In some examples, the time-series may be converted to a time-series of voltage-changes and/or current-changes. The voltage-changes and/or current-changes may be generated by subtracting one term in the time-series of voltage-measurements and current-measurements from an adjacent term in the series.

More generally, such a time-series may be considered a time-series of consumption-changes, and may indicate a change in electrical load. In an example, the time-series may be examined for changes in electrical load that indicate the start and/or end of an electrical vehicle charging event.

The smart meter 106 may include a radio and antenna 124. Alternatively, the smart meter may include a PLC modem or other communications device. The smart meter 106 may also include a battery and/or a power supply 126. In the example of a system configured as an electricity grid, a battery is not required. A power supply is configured to provide regulated direct current (DC) power at prescribed voltage levels for operation of the processor 114, the memory device 116, the radio 124, and/or other devices. A bus, printed circuit board, wiring harness, and/or other circuit connectivity device(s) 128 may be used to connect the processor 114, the memory device 116, the metrology devices 122, the radio 124, and the power supply 126.

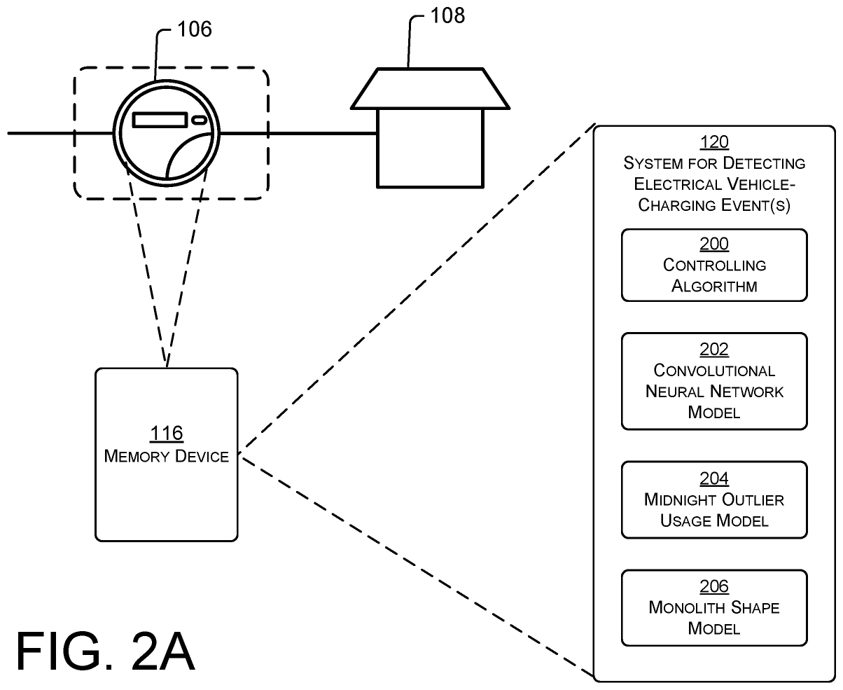

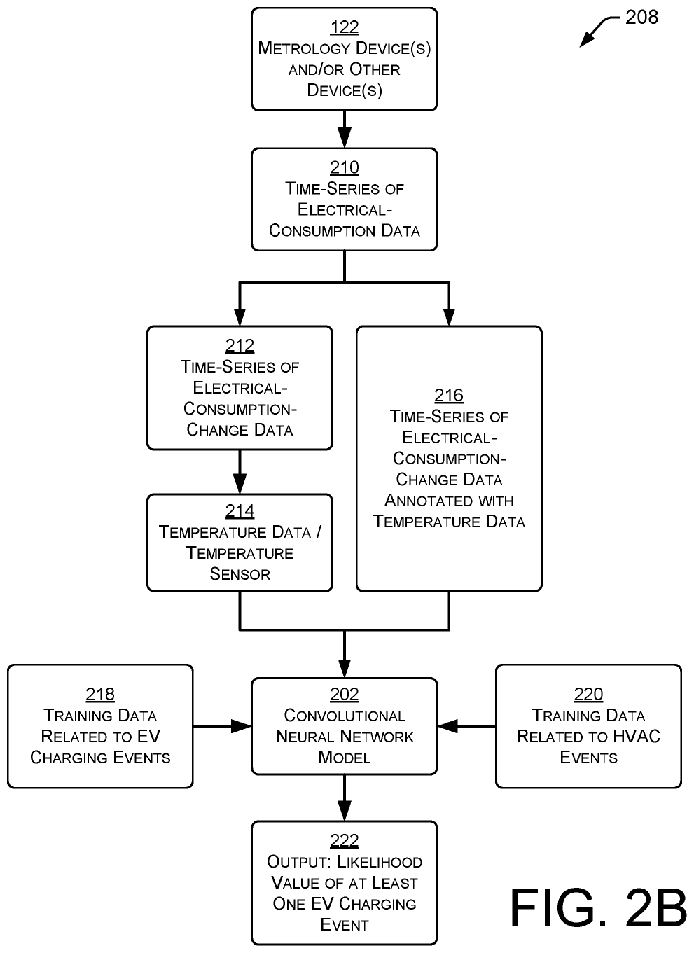

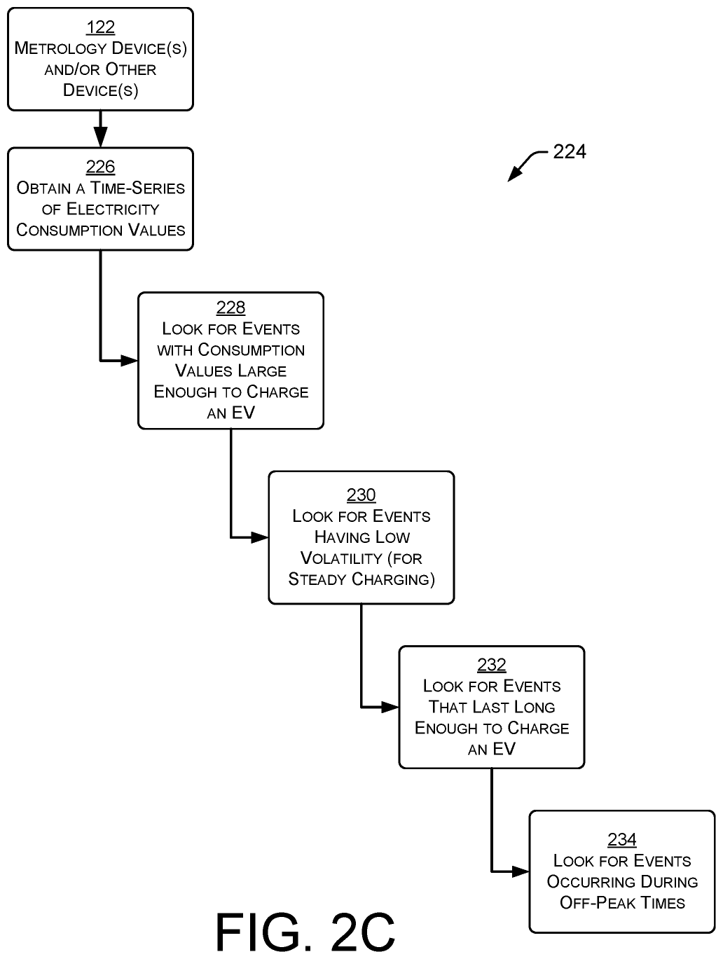

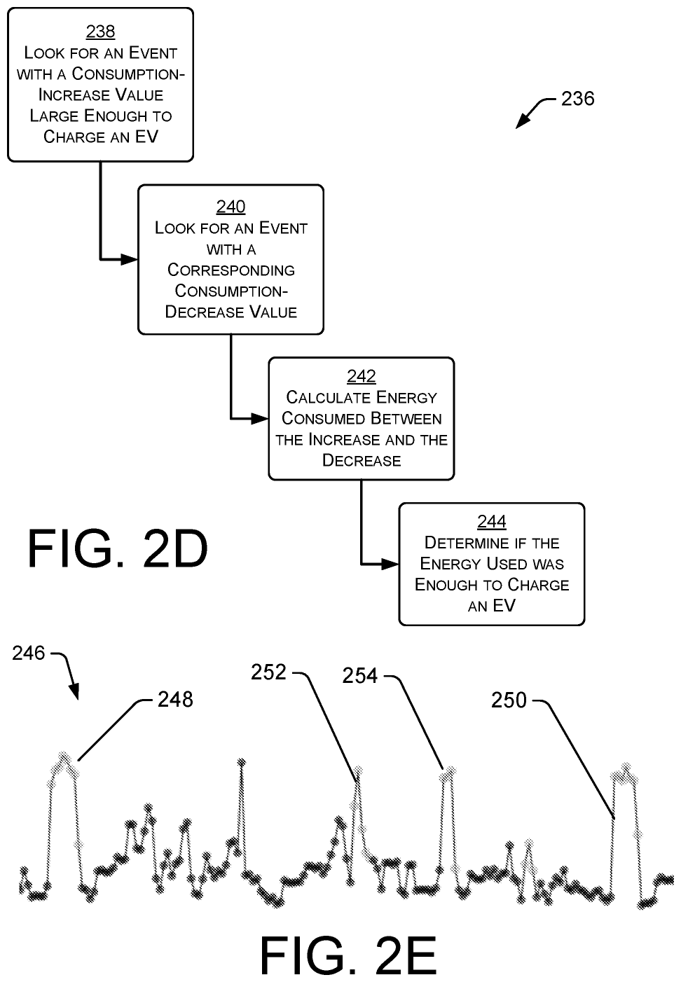

FIG. 2A shows an example configuration of portions of the system 120 for detecting electrical vehicle-charging event(s). The system 112 could be configured in a similar manner. Alternatively, portions of the example system 120 shown in FIG. 2 could be distributed among cooperative and/or distributed systems operable on the metering device and the cloud/server device.

In the example of FIG. 2A, the memory device 116 contains the system 120 for detecting electrical vehicle-charging event(s). A controlling algorithm 200 may select, coordinate the operation of, and/or execute one or more models. The models may be applications, subroutines, software, etc., configured to locate electrical service sites that are used to charge one or more electrical vehicles. In some example implementations, the controlling algorithm 200 is also capable of transforming the gathered data from metrology devices into a shape and/or format that is consistent with the expected input of one or more models (i.e., turning 1-minute interval data into 30-minute interval data, specifying and/or selecting only the desired time range, etc.). The controlling algorithm may also be at least partly responsible for the aggregation and/or coalescence of output from one or more of the models.

In the example of FIG. 2A, a convolutional neural network model 202, a midnight outlier usage model 204, and a monolith shape model 206 are shown. Operation of these models can be directed by the controlling algorithm 200 in complimentary and synergistically interacting manner(s). Alternatively, the controlling algorithm 200 may operate any of the models 202-206 individually to detect EV charging activities.

### Overview of Convolutional Neural Network Model

In an example, a convolutional neural network model provides a first method of detecting electric vehicle (EV) charging. In the example, a time-series of electrical-consumption data of a service site is obtained over a time-range. The time-series of electrical-consumption data is converted into a time-series of consumption-change data. Temperature data is associated with at least some of the terms of the time-series of consumption-change data to thereby create input data over the time-range. That is, an ambient temperature at the service site, neighborhood, and/or city obtained at the time a term in the time-series was measured are associated. Thus, voltage, current, and temperature measurements are associated in terms of the time series. The input data is provided over the time-range to a machine-learned model. That is, a neural network model that has previously been trained with data (e.g., labeled data) receives the input data. The input data is processed over the time-range in the neural network model to generate output, wherein the output comprises a likelihood value of at least one EV charging event during the time-range. Output is received from the machine-learned model.

FIG. 2B shows an example overview 208 of a convolutional neural network model. The metrology device(s) 122 may measure electricity usage and create a time-series of electrical-consumption data 210. Using the consumption data, a time-series of electrical consumption change-data 212 is created. The changes within the change-data will include increases and decreases, such as if a load (e.g., an appliance) is turned on or off, respectively. Temperature data 214 may be obtained from a temperature sensor. Block 216 shows an alternative, wherein the time-series of electrical-consumption change-data is annotated with temperature data. Thus, block 216 shows an alternative data format.

The convolutional neural network 202 (or other machine learning algorithm) may be trained by using labeled training data 218 related to EV charging events. Such data helps the model recognize EV charging events. In contrast, labeled training data 220 related to heating, ventilation, and air-conditioning (HVAC) helps the model distinguish EV charging events and HVAC events. The convolutional neural network 202 provides output 222, which may indicate a value (e.g., percentage chance) of an EV charging event having taken place.

### Overview of Midnight Outlier Usage Model

In an example, a midnight outlier usage model provides a second method of detecting EV charging. In the example, data (e.g., data including a time-range of a time-series of electricity consumption values at a service site) is read into the model. An average and a standard deviation of the time-series of electricity consumption values is computed. An average and a standard deviation of a time-series of changes in electricity consumption values is computed.

First outlier usage events are identified. The first outlier usage events may have respective rates of consumption that are more than a first threshold value greater than (for example) a mean usage value of the time-series of electricity consumption values. In other examples, the first threshold value may be greater than an average consumption level, a historic consumption level, a consumption level immediately preceding the increase in consumption of the first outlier usage event, etc. In an example of the first threshold, the first outlier usage events have respective rates of consumption that are at least 3 standard deviations away from a mean usage value of the time-series of electricity consumption values.

Second outlier events are identified from among the first outlier usage events. The second outlier usage events have volatility that is less than a second threshold value. In an example, the second outlier usage events may be identified due to their volatility within 2 standard deviations away from an average change in the time-series of changes in electricity consumption values.

Third outlier usage events are identified from among the second outlier usage events. In an example, the third outlier events last a third threshold period of time or longer. Thus, the third outlier events last a period of time that indicates the possibility of association with EV charging.

Using the time-series (wherein each term may be associated a time, a current flow, a voltage level, and/or a temperature), a time of day is calculated during which each of the third outlier usage events occur. While the time of day may be calculated for each of the third outlier usage events, the time of day could also be calculated at a different time, i.e., associated with different outlier events. For example, the time of day could be associated with each of the first outlier events. However, since the third outlier events are a subset of the second outlier events, which are a subset of the first outlier events, it may be more efficient to calculate the time of day for each of the third outlier events.

Fourth outlier usage event(s) are identified from among the third outlier events. The fourth outlier usage events are identified as being associated with (i.e., taking place during) a time of day that is within off-peak hours.

The fourth outlier usage event(s) are flagged as exhibiting EV charging behavior. This may result in changing which service sites are supported by different transformers, which transformers are supported by different phases of medium voltage lines, and/or electricity rates for different hours of the day at different service sites to promote EV charging when power is more readily available.

Note that each of group of outlier events (i.e., the first, second, third, and fourth sets of outlier events) are associated with a “test,” e.g.,

FIG. 2C shows an example overview 224 of a midnight outlier usage model. Metrology device(s) 122 provide a time-series of electricity-consumption values 226. Four example steps are shown by which consumption values 226 are narrowed to result in suspected EV charging events. At block 228, events with consumption great enough (e.g., more than a threshold) to charge an EV are found. At block 230, those events are evaluated for volatility since low volatility is generally a characteristic of EV charging. At block 232, those events are evaluated for a duration over a threshold since time is required to charge an EV. At block 234, those events are evaluated for occurring at off-peak times since many owners charge their EVs during the off-peak times. The consumption events having some, most, or all of the characteristics of actions 228-234 are considered likely EV charging events.

### Overview of Monolith Shape Model

In an example, a monolith shape model provides a third method of detecting EV charging. In the example, a consumption increase at a metering device is determined to be greater than a first threshold value.

The consumption is determined to have been maintained at the metering device without a decrease greater than a second threshold value for a third threshold period of time.

A consumption decrease at the metering device is determined to be greater than a fourth threshold value, with the consumption decrease occurring after conclusion of the third threshold period of time. A consumption decrease of sufficient magnitude is indicative of the conclusion of an EV charging event.

Energy consumption is calculated, based at least in part on a magnitude of the consumption increase, and based at least in part on a duration of time between the consumption increase and the consumption decrease. The energy consumption is determined to have exceeded a fifth threshold value. The fifth threshold may be set to indicate energy consumption that is great enough to be the result of EV charging. Accordingly, the energy consumption is flagged as an EV charging event. In an example, the fifth threshold used to identify a single EV charging event. In a further example, the fifth threshold may be used to identify a weekly total of suspected EV charging events. In a further example, the fifth threshold may be compared to a weekly total of suspected EV charging events that occurred in off-peak hours.

FIG. 2D shows an example overview 236 of a monolith shape model. At block 238, a consumption-increase large enough to charge an EV (e.g., using a typical or a particular charging device) is recognized. A threshold may be set according to the typical or the particular charging device. At block 240, a corresponding consumption-decrease is recognized, thereby indicating the end of the charging period. At block 242, the energy consumed during the charging period is calculated (e.g., as kilowatt hours). At block 244, the energy is compared to a typical or a particular EV charging event.

FIG. 2E shows an example 246 time-series of consumption values and shows how consumption changes may or may not indicate EV charging events based on the monolith shape model. Charging events 248 and 250 may indicate EV charging events. Each event 248, 250 has a significant (and similar) increase and decrease in consumption, separated by enough time for energy sufficient to charge an EV to be delivered. In contrast, events 252, 254 may not have resulted in sufficient energy to indicate EV charging events. These events may be related to HVAC or other activity. Moreover, the consumption decrease associated with event 252 does not closely correspond with the consumption increase. Other consumption changes lack several of the characteristics of blocks 238-244, and are therefore not EV charging events.

### Example Methods

In some examples of the techniques discussed herein, the methods of operation may be performed by one or more application specific integrated circuits (ASIC) or may be performed by a general-purpose processor utilizing software defined in computer readable media. In the examples and techniques discussed herein, the memory 116 may comprise computer-readable media and may take the form of volatile memory, such as random-access memory (RAM) and/or non-volatile memory, such as read only memory (ROM) or flash RAM. Computer-readable media devices include volatile and non-volatile, removable, and non-removable media implemented in any method or technology for storage of information such as computer-readable instructions, data structures, program modules, or other data for execution by one or more processors of a computing device. Examples of computer-readable media include, but are not limited to, phase change memory (PRAM), static random-access memory (SRAM), dynamic random-access memory (DRAM), other types of random access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transitory medium that can be used to store information for access by a computing device.

As defined herein, computer-readable media includes non-transitory media, and does not include transitory media, such as modulated data signals and carrier waves, and/or other information-containing signals.

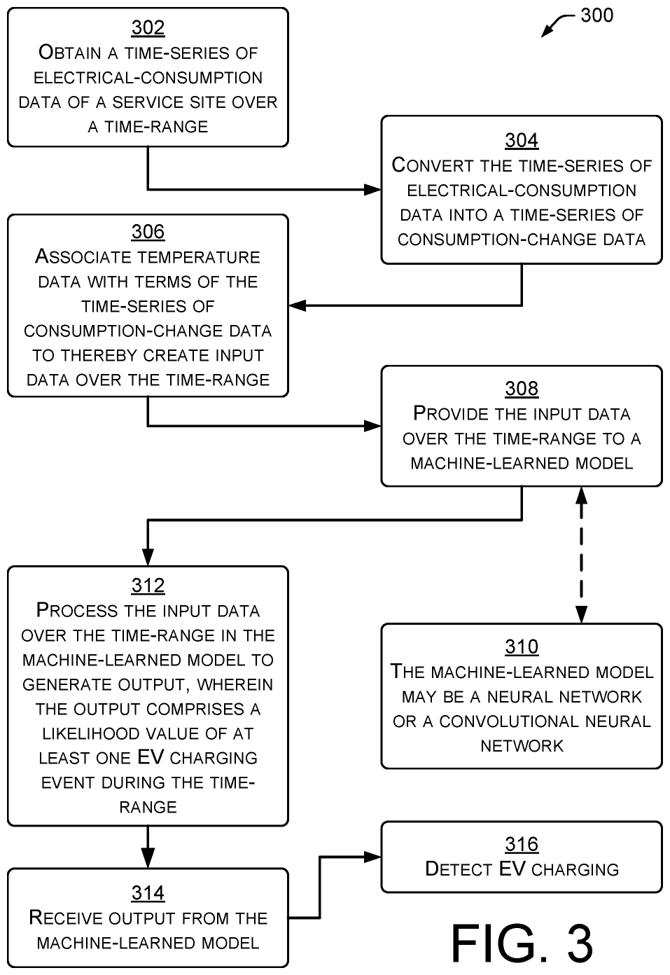

FIG. 3 shows an example of a convolutional neural network model 300 (and/or machine-learned model and/or subroutine-implemented algorithm) utilized to detect EV charging at customers' service sites.

At block 302, a time-series of electrical-consumption data is obtained. The time-series of electrical-consumption data may be associated with a service site, and the terms of the time-series may be collected by an electricity meter at the service site over a time-range. Each term in the time-series may be associated with a time of day, a voltage level, and a current flow rate. Accordingly, the time-series describes activity at the service site, such as consumption activity and/or ambient temperature, etc.

At block 304, the time-series of electrical-consumption data is converted into a time-series of consumption-change data. In an example, the difference between adjacent terms in the time-series of electrical-consumption can be used to create the terms of the time-series of consumption-change data. For example, one term in the time-series of electrical-consumption data may be 120 volts and 20.3 Amps, while the next term (e.g., associated with measurements one second later) may be 120 volts and 35.6 Amps. Thus the new term in the time-series of consumption-change data would be: voltage change 0 volts; current change +15.3 Amps.

At block 306, temperature data may be associated with terms of the time-series of consumption-change data. The temperature data may be an ambient temperature at the service site, service site neighborhood, service site city, etc. The temperature data may be annotated to, or meta data of, some or all terms of the time-series of consumption-change data. The temperature-annotated time-series of consumption-change data may be used as input data to a model (e.g., a machine-learned model). The number of terms and the time between them indicate a time-range of the time-series.

At block 308, the input data over the time-range is provided to a model. In the example of block 310, the model may be a machine-learned model, a neural network, a convolutional neural network, a software-defined algorithm, and/or a programming subroutine, etc.

At block 312, the input data may be processed—by a model described by block 310—over the time-range of the data. In an example, the machine-learned model will process input data and generate output data. In the example, the output comprises a likelihood value (e.g., a percentage chance, probability, and/or odds) of at least one EV charging event during the time-range.

At block 314, output from the machine-learned model is received. In the example of block 316, the model indicates that EV charging was detected.

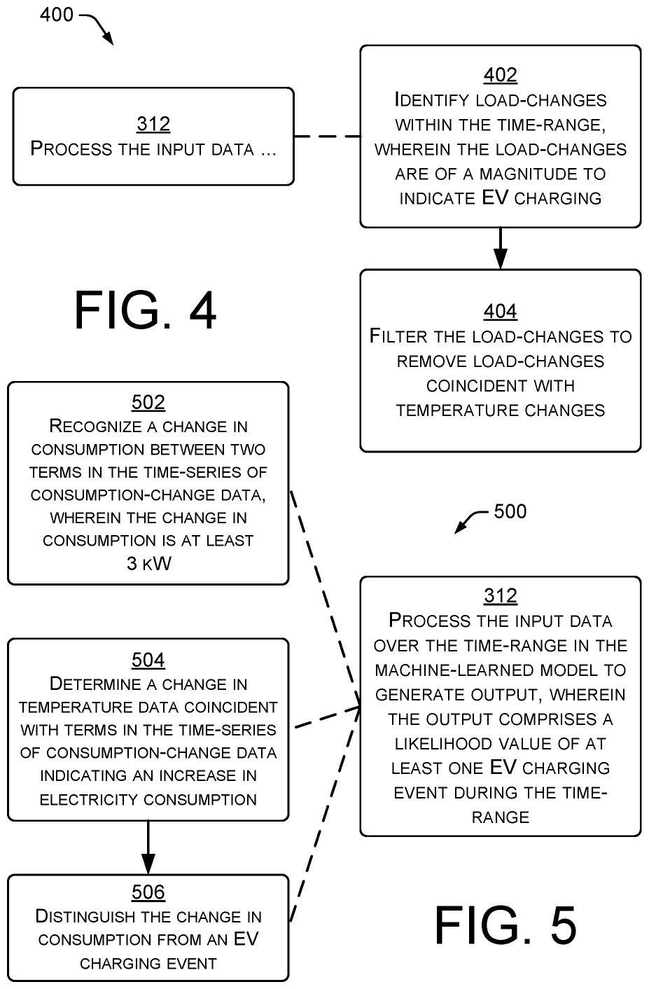

FIG. 4 shows example techniques 400 for providing input to the model. Accordingly, techniques 400 are an example implementation of block 312 of FIG. 3 or other block related to the input and/or processing of data. At block 402, load-changes are identified within the time-range, wherein the load-changes are of a magnitude to indicate EV charging. That is, the power (or current) seen in the load-change must be significant enough (e.g., over a settable threshold value) to charge an EV. At block 404, the load-changes (i.e., the load-changes from block 402, that exceed a threshold value) are filtered to remove load-changes coincident with temperature changes. In an example, a temperature change can result in false positive indications of EV charging. Such load changes may instead be related to heating, ventilation, and/or air conditioning (HVAC), which may have load values comparable to EV charging.

FIG. 5 shows example techniques 500 for processing data in the model to determine a likelihood of EV charging at a service site (e.g., a customer site). Accordingly, techniques 500 are further example implementations of block 312 of FIG. 3. A first example is seen at block 502, where a change in consumption is recognized between two terms in the time-series of consumption-change data. In an example, the change in consumption may be 3000 Watts-hours.

A second example is seen at blocks 504 and 506. At block 504, a change in temperature data coincident with terms in the time-series of consumption-change data is determined. In the example, the change may indicate an increase in electricity consumption. At block 506, the change in consumption is distinguished from an EV charging event. Thus, a possible EV charging event may be classified as being related to HVAC causes due to the temperature change recognized at block 504.

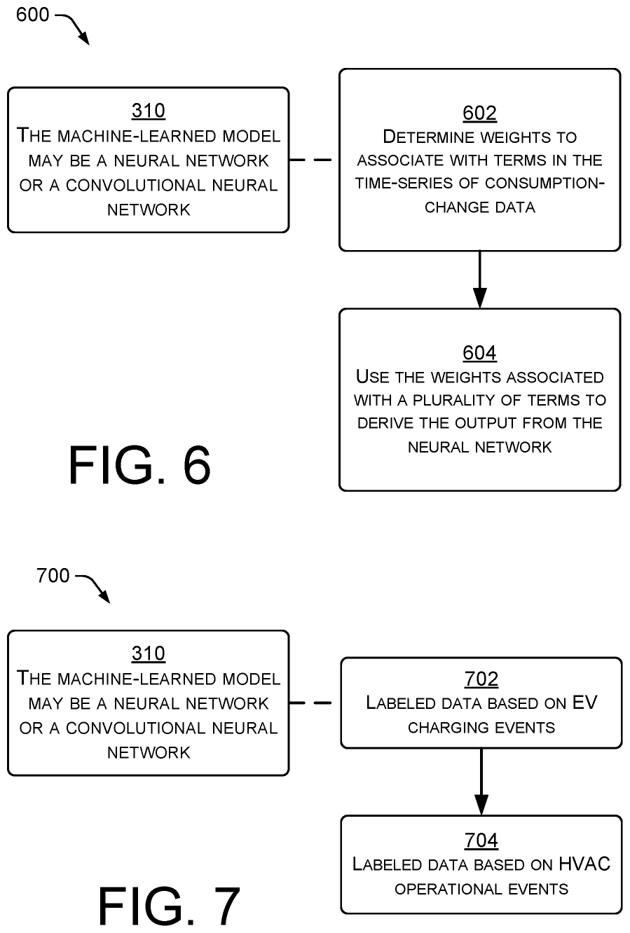

FIG. 6 shows example techniques 600 for training a neural network or convolutional neural network. Accordingly, techniques 600 are an example of aspects of the implementation of block 310 of FIG. 3, if the model is a machine-learned model, such as a neural network and/or a convolutional neural network. At block 602 in a manner consistent with neural networks, respective weights are determined for association with respective terms in the time-series of consumption-change data. The “weights” in the neural network (convolutional or otherwise) are related to the inner workings and mathematics of the architecture of the neural network. When passing training data into the model or neural network (i.e., in the format of labelled data), these weights are adjusted such that the “loss” (or degree of mis-match between the input data and the expected output data) is minimized. In an example, it is possible to manually adjust any of the weights in the model to produce desired results (recognition of EV charging events, distinguishing HVAC events, etc.). At block 604, the weights associated with a plurality of terms are used (in some cases, along with other factors, inputs, etc.) to derive the output from the neural network.

FIG. 7 shows additional example techniques 700 for training a neural network or convolutional neural network. Machine-learned models may be trained using techniques for providing inputs that are consistent with known outputs. For example, data resulting from known EV charging may be used to train a model to recognize an EV charging event. Similarly, data resulting from known HVAC operation may be used to train a model to recognize an HVAC charging event (and to thereby distinguish such events from EV charging events). At block 702, labeled data that is known to be based on EV charging events can be used in the training. The “label” may be meta data associated with consumption data, and may indicate the origin or cause of the data (e.g., consumption values resulting from the charging of a particular EV). At block 704, labeled data is based on HVAC operational events. The use of consumption data resulting from both EV-charging and HVAC-operation helps the model to distinguish HVAC consumption from EV-charging consumption.

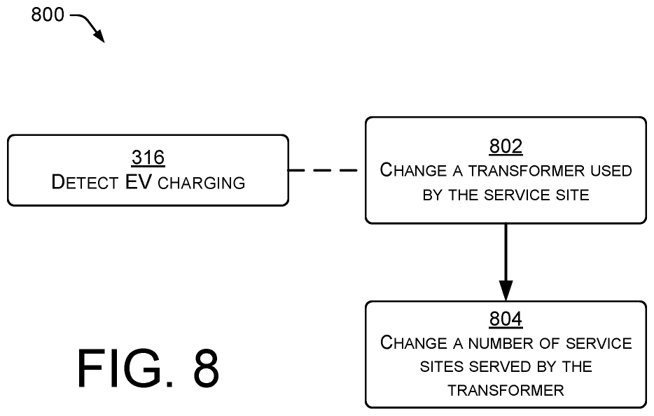

FIG. 8 shows example techniques 800 used in response to detection 316 of EV charging at a service site. At block 802, a transformer used by the service site is changed, such as from a more heavily loaded transformer to a less heavily loaded transformer. In an alternative seen at block 804, a number of service sites served by the transformer may be changed. In an example, if three service sites are served by a transformer, and one of the service sites begins to charge an EV, it may be time to move another of the service sites to a different transformer. Thus, the stress level of transformers may be adjusted to avoid over-stressing any transformer. Also, the phases of power may also be re-balanced responsive to a new EV-charging load. Phase load may be balanced by moving transformers between different phases of power, or customer sites between different transformers connected to different phases.

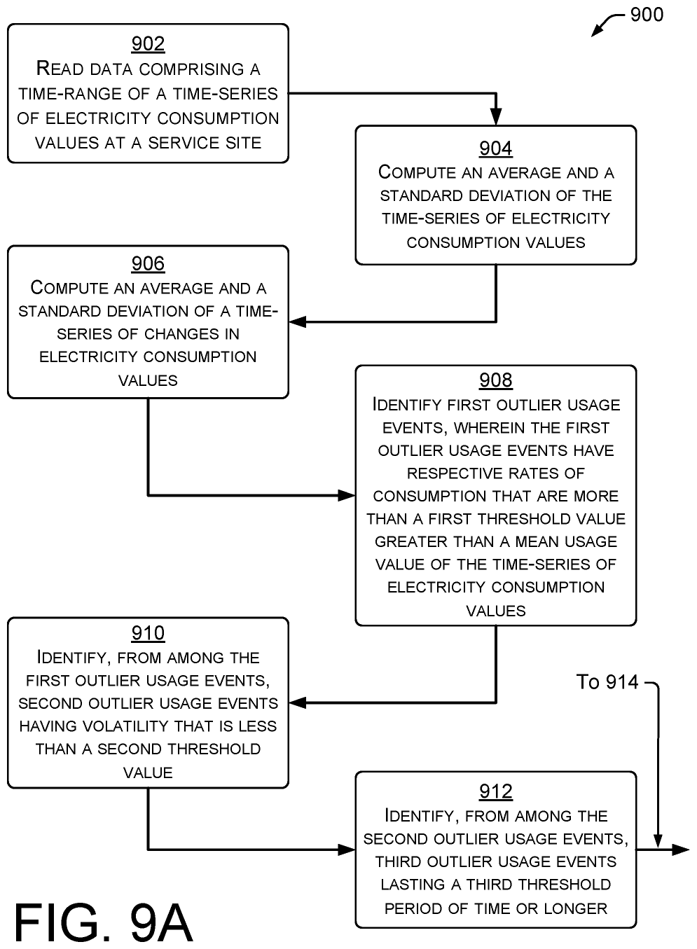

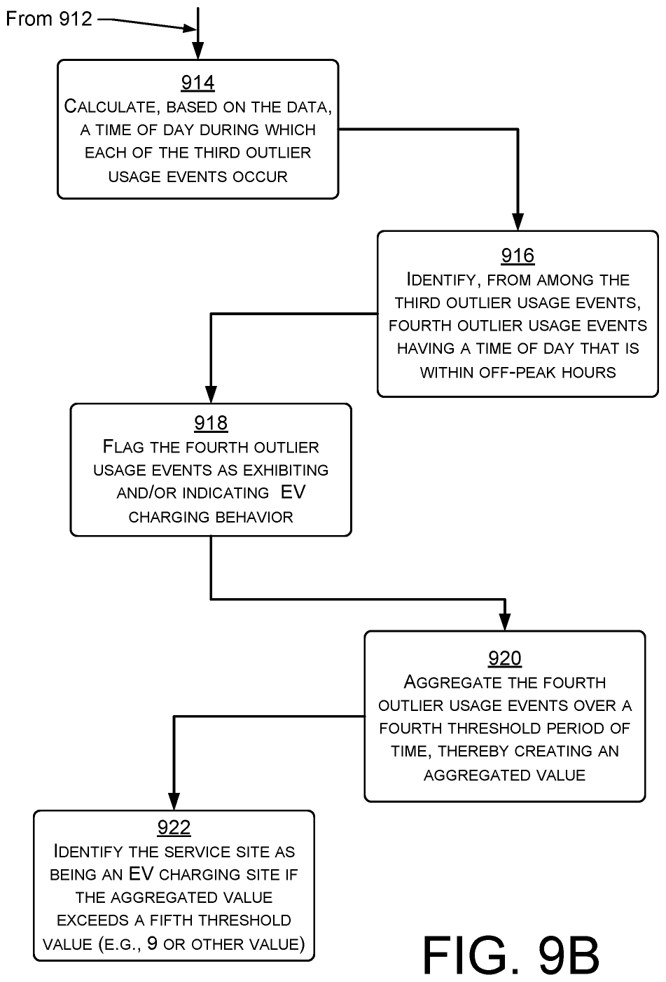

FIGS. 9A and 9B show an example 900 of a midnight outlier usage model utilized to detect EV charging. At block 902, data comprising a time-range of a time-series of electricity consumption values is read (or obtained, or measured, such as by an electricity meter) at a service site.

At block 904, an average and a standard deviation of the time-series of electricity consumption values is computed.

At block 906, an average and a standard deviation of a time-series of changes in electricity consumption values is computed. Note that the time-series of changes in electricity consumption values can be obtained from the time-series of electricity consumption values.

At block 908, first outlier usage events are identified. In an example, the first outlier usage events have respective rates of consumption that are more than a first threshold value greater than a mean usage value of the time-series of electricity consumption values. Because of their rates of consumption, the first outlier events are plausible EV-charging events.

At block 910, second outlier usage events having volatility that is less than a second threshold value are identified from among the first outlier usage events. That is, some or all of the first outlier events may be checked for volatility, and those with less than the second threshold value are selected. Less volatility is consistent with the steady flow of current in the EV charging process.

At block 912, third outlier usage events lasting a third threshold period of time or longer are identified from among the second outlier usage events. In an example, the second outlier events are searched for events lasting long enough to provide a significant charge to an EV, thereby creating the third outlier events.

At block 914, a time of day during which each of the third outlier usage events occurred is calculated, based on the data. In an example, the time-series data may associate a time of day with an event, such as voltage and current levels measured by an electricity meter.

At block 916, fourth outlier usage events having a time of day that is within off-peak hours are identified from among the third outlier usage events. Thus, the third outlier events are filtered to result in the fourth outlier events by removing those that are not during off-peak hours. This is consistent with the common practice of charging EVs during the night.

At block 918, the fourth outlier usage events are flagged as exhibiting and/or indicating EV charging behavior. Thus, from a number of consumption events (e.g., changes in electricity consumption rate indicating possible EV charging) a smaller number of events exhibiting EV charging behavior are identified.

At block 920, the fourth outlier usage events are aggregated over a fourth threshold period of time, thereby creating an aggregated value per time period. In an example, the aggregated value is a measure of expected, measured, and/or calculated EV charging events per time-period, such as a number of events per week, month, year, etc. At block 922, the service site is identified as being an EV charging site if the aggregated value exceeds a fifth threshold value. In an example, the fifth threshold value may be 9. Alternatively, it may be another value.

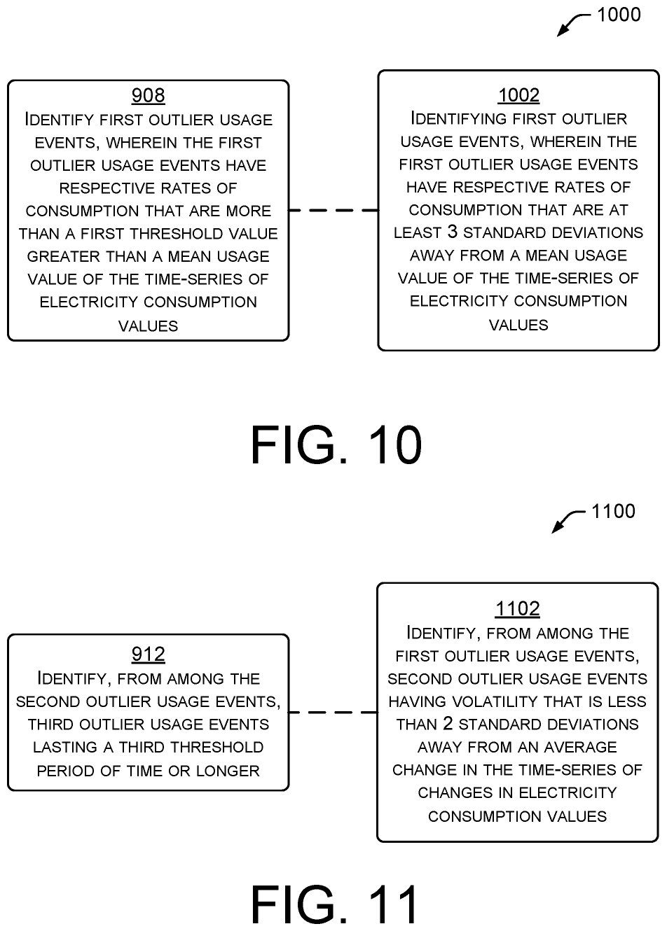

FIG. 10 shows example techniques 1000 for identifying outlier events having consumption values that are sufficiently large to indicate possible EV charging activity. Accordingly, techniques 1000 are example aspects implementing block 908 of FIG. 9. At block 1002, first outlier usage events are identified. In an example, the first outlier usage events have respective rates of consumption that are at least 3 standard deviations away from a mean usage value of the time-series of electricity consumption values. Thus, the first outlier usage events are events wherein a change in consumption is great enough to be suspected of association with EV charging activities.

FIG. 11 shows an example technique 1100 for processing, refining, and/or filtering the second outlier events to recognize third outlier events having a duration over a threshold. At block 1102, second outlier usage events are identified from among the first outlier usage events. The second outlier usage events are selected for having volatility that is less than 2 standard deviations away from an average change in the time-series of changes in electricity consumption values. Accordingly, the second outlier events are filtered for events lasting long enough to significantly charge an EV, thereby creating the third outlier events.

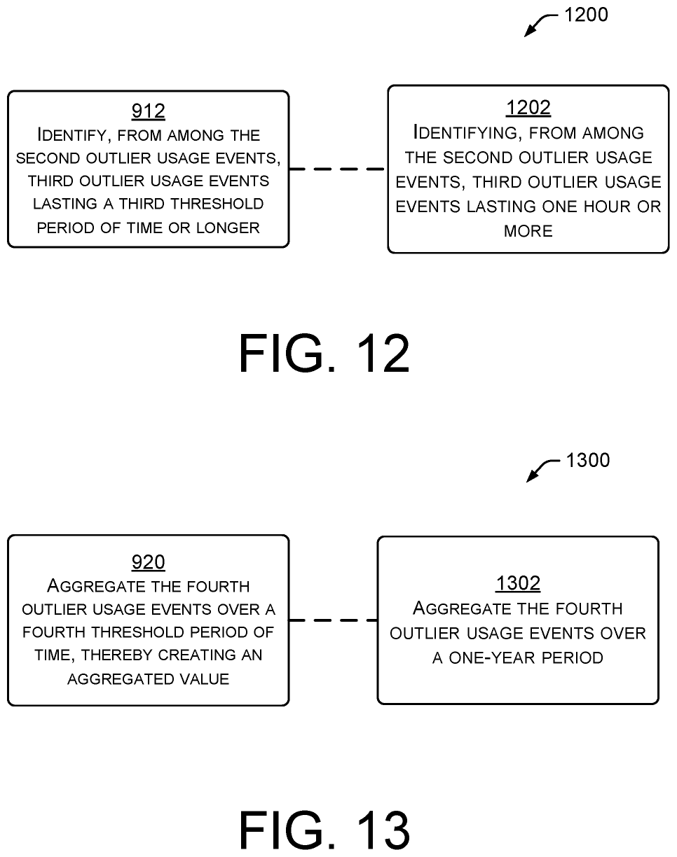

FIG. 12 shows an example technique 1200 for processing, refining, and/or filtering the second outlier events to recognize third outlier events. At block 1202, third outlier usage events lasting one-hour or more are identified from among the second outlier usage events. The duration of the third outlier usage events is an adjustable setting; for example, a threshold may be set for a value from one to four-hours. A shorter threshold value (e.g., one hour) may identify more EV charging events, but may also identify more HVAC events.

FIG. 13 shows example technique 1300 for aggregating the fourth outlier events. At block 1302, the fourth outlier usage events are aggregated over a one-year period. An aggregation process of longer duration may result in greater certainty of EV charging events at a service site. However, the longer duration also delays remedial measures, such as moving service sites between transformers and/or moving transformers between phases of medium voltage lines. Accordingly, the aggregation process may balance these goals.

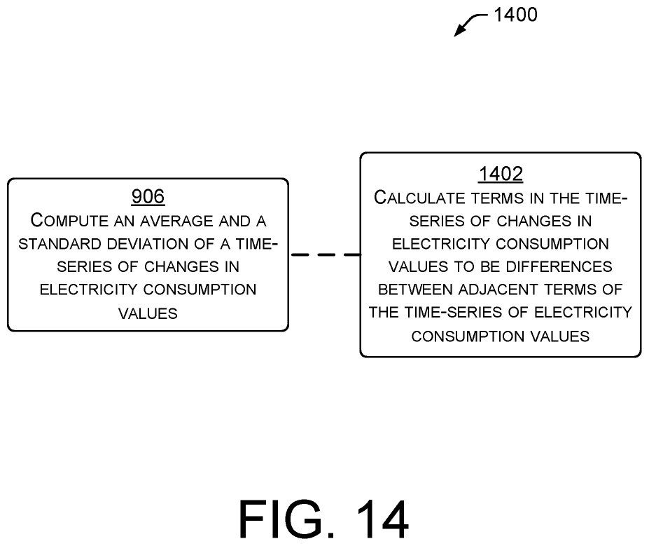

FIG. 14 shows example techniques 1400 for computing a time-series of changes in electricity consumption. At block 1402, terms in the time-series of changes in electricity consumption values may be calculated as the differences between adjacent terms of the time-series of electricity consumption values.

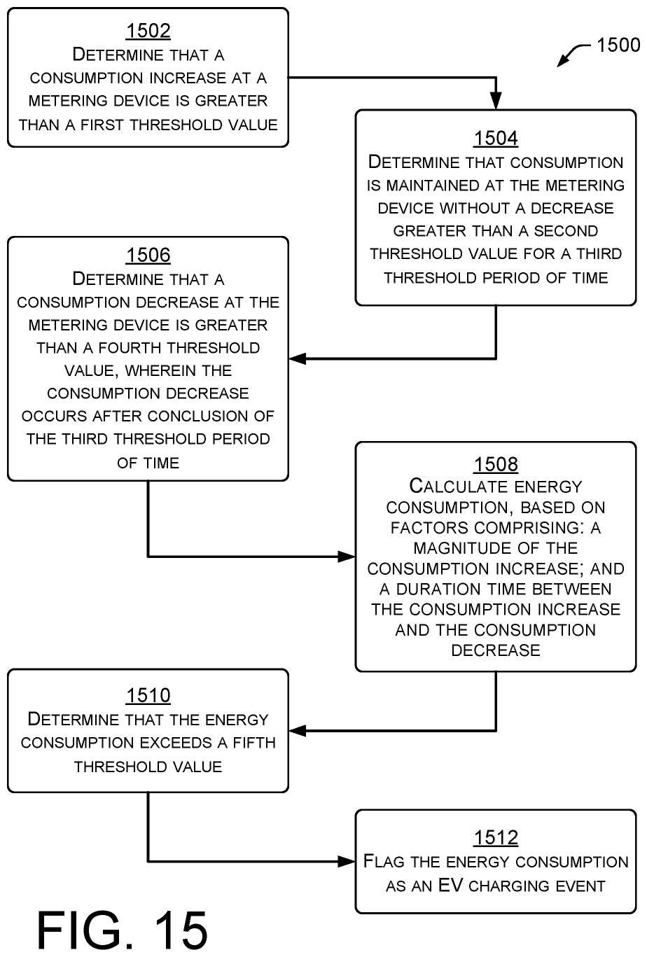

FIG. 15 shows an example 1500 of a monolithic shape model utilized to detect electric vehicle EV charging. At block 1502, a consumption increase at a metering device is determined to be greater than a first threshold value. The first threshold value may be selected to be large enough to plausibly result from an EV charger turning on.

At block 1504, it is determined that consumption is maintained at the metering device without a decrease greater than a second threshold value for a third threshold period of time. This is indicative of EV charging, since steady consumption over a significant period of time is generally the case.

At block 1506, it is determined that a consumption decrease at the metering device is greater than a fourth threshold value, wherein the consumption decrease occurs after conclusion of the third threshold period of time. This is indicative of EV charging, since consumption decreases markedly upon conclusion of the charging period.

At block 1508, energy consumption of the suspected EV charging event is calculated and/or estimated. The calculation may be based on factors including a magnitude of the consumption increase and a duration time between the consumption increase and the consumption decrease. The calculation may involve multiplying Watts times hours to obtain the energy value in kWh.

At block 1510, it may be determined that the energy consumption exceeds a fifth threshold value. The fifth threshold value may be selected based on the energy required to charge an EV vehicle's battery from a partially discharged state.

At block 1512, the energy consumption may be flagged as an EV charging event. The flagging of an EV charging event may indicate that the site of the event is flagged as a service site having an EV vehicle and performing EV charging. In a further example, the site may be flagged for a week if more than a sixth threshold number of EV charging events are identified (e.g., one or two events). The site may be flagged for a year having more than a seventh threshold number of flagged weeks (e.g., 25 weeks). Upon being flagged for a year, the likelihood of the service site may be flagged as having an EV vehicle and regularly performing EV charging.

FIG. 16 shows example techniques 1600 for evaluating consumption increases. Accordingly, the techniques 1600 are example aspects implementing block 1502 of FIG. 15. At block 1602, it is determined that a term (e.g., a “first term”) in a time-series of consumption changes indicates an increase in consumption of the first threshold value or more. The first threshold is set at a value that indicates the start of an EV charging event. Thus, two adjacent terms in the time-series of electrical-consumption data (e.g., measured by an electricity meter at a service site) may indicate a sharp increase in consumption. The difference between two such terms would be a term in the time-series of consumption changes.

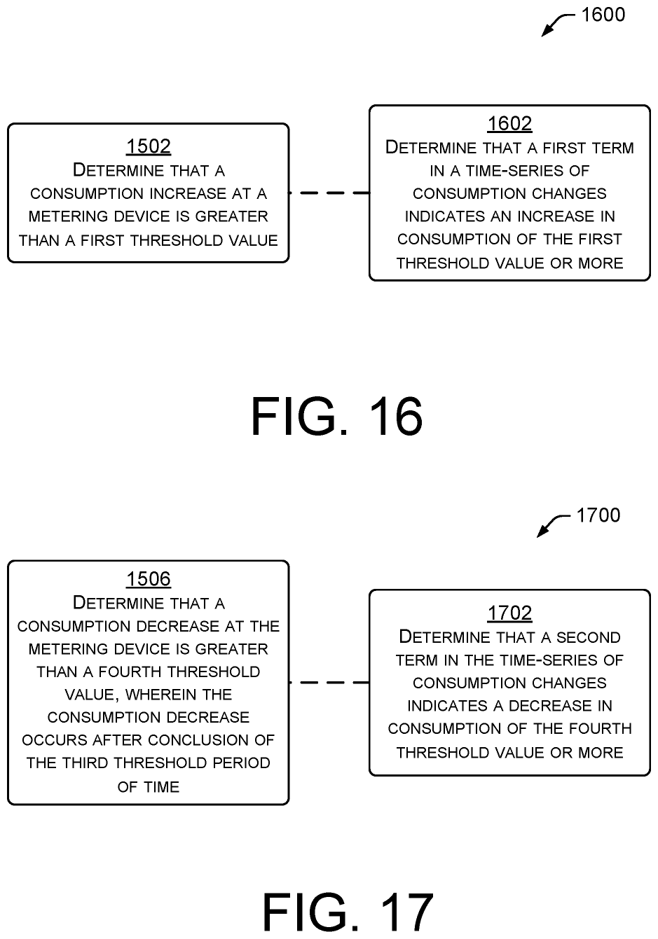

FIG. 17 shows example techniques 1700 for evaluating consumption decreases. Accordingly, the techniques 1700 are example aspects implementing block 1506 of FIG. 15. At block 1702, it is determined that a second term in the time-series of consumption changes indicates a decrease in consumption of the fourth threshold value or more. The fourth threshold is set at a value that indicates the end of the EV charging event. In some examples, the first threshold and the fourth threshold may be approximately the same. However, if the current used by a charger tapers off as the battery is charged, then the fourth threshold may be less than the first threshold.

### Example Convolutional Neural Network Model Systems and Devices

The disclosure describes three complimentary, synergistically interacting, and yet individually capable techniques for detecting electrical vehicle charging activities. The convolutional neural network techniques find “edges” or points of significant change in electricity consumption. Time-series of electricity consumption are examined, and temperature is considered to normalize for changes in heating, ventilation, and air conditioning (HVAC) consumption. In an example, a time-series of electrical-consumption data of a service site is obtained over a time-range. The time-series of electrical-consumption data is converted into a time-series of consumption-change data. Temperature data may be associated with terms of the time-series of consumption-change data to thereby create input data for a machine-learned algorithm over the time-range. The input data is provided to a machine-learned model. The input data is processed over the time-range in the machine-learned model to generate output, such as a likelihood value of at least one EV charging event during the time-range.

The following examples of a convolution neural network (or a machine-learned model) are expressed as numbered clauses. While the examples illustrate a number of possible configurations and techniques, they are not meant to be an exhaustive listing of the systems, methods, and/or techniques described herein.

1. A method of detecting electric vehicle (EV) charging, comprising: obtaining a time-series of electrical-consumption data of a service site over a time-range; converting the time-series of electrical-consumption data into a time-series of consumption-change data; associating temperature data with terms of the time-series of consumption-change data to thereby create input data over the time-range; providing the input data over the time-range to a machine-learned model; processing the input data over the time-range in the machine-learned model to generate output, wherein the output comprises a likelihood value of at least one EV charging event during the time-range; and receiving output from the machine-learned model.

2. The method of clause 1, wherein processing the input data over the time-range in the machine-learned model comprises: recognizing a change in consumption between two terms in the time-series of consumption-change data, wherein the change in consumption is greater than a threshold value.

3. The method of clause 1, wherein the machine-learned model comprises a convolutional neural network (CNN), and wherein processing the input data over the time-range in the neural network comprises: determining weights to associate with terms in the time-series of consumption-change data; and using the weights associated with a plurality of terms to derive the output from the neural network.

4. The method of clause 1, wherein the machine-learned model comprises a convolutional neural network (CNN), and wherein the CNN is trained on input comprising: labeled data based on EV charging events; and labeled data based on HVAC operational events.

5. The method of clause 1, additionally comprising: determining a change in temperature data coincident with terms in the time-series of consumption-change data indicating an increase in electricity consumption; and distinguishing the change in consumption from an EV charging event.

6. The method of clause 1, additionally comprising, responsive to detection of an EV charging event performing at least one of: changing a transformer used by the service site; changing a number of service sites served by the transformer; or changing a phase of electricity provided to the transformer.

7. The method of clause 1, wherein: the likelihood value comprises a value from 0.0 to 1.0; and the time-range is one week.

8. The method of clause 1, additionally comprising one or more or all of any of the preceding clauses.

9. A computing device to detect electric vehicle (EV) charging events, wherein the computing device comprises: a processor; and a memory device, in communication with the processor, wherein the memory device comprises statements executed by the processor to perform actions comprising: obtaining a time-series of electrical-consumption data of a service site over a time-range; converting the time-series of electrical-consumption data into a time-series of consumption-change data; associating temperature data with terms of the time-series of consumption-change data to thereby create input data over the time-range; providing the input data over the time-range to a subroutine configured to detect EV charging incidents, wherein the subroutine performs actions comprising: identifying load-changes within the time-range, wherein the load-changes are of a magnitude to indicate EV charging; and filtering the load-changes to remove load-changes coincident with temperature changes; and responsive to the subroutine recognizing one or more possible EV charging incidents, determining a likelihood of at least one EV charging event during the time-range based at least in part on the one or more possible EV charging events.

10. The computing device of clause 9, wherein identifying load-changes within the time-range by the subroutine comprises: recognizing a change in consumption between two terms in the time-series of consumption-change data, wherein the change in consumption is 3 kWh or more.

11. The computing device of clause 9, wherein the subroutine comprises a convolutional neural network (CNN), and wherein the subroutine performs additional actions comprising: determining weights to associate with terms in the time-series of consumption-change data; and using the weights associated with a plurality of terms to derive an output from the CNN.

12. The computing device of clause 9, wherein the subroutine comprises a convolutional neural network (CNN), and wherein the CNN is trained on input comprising: labeled data based on EV charging events; and labeled data based on HVAC operational events.

13. The computing device of clause 9, additionally comprising: determining a change in temperature data coincident with terms in the time-series of consumption-change data indicating an increase in electricity consumption; and distinguishing the change in consumption from an EV charging event.

14. The computing device of clause 9, based at least in part on the likelihood of the at least one EV charging event, performing at least one of: changing a transformer used by the service site; or changing a number of service sites served by the transformer.

15. The computing device of clause 9, wherein: the likelihood comprises a value from 0.0 to 1.0; and the time-range is one week.

16. The computing device of clause 9, additionally comprising one or more or all of any of the preceding clauses.

17. One or more non-transitory computer-readable media storing computer-executable instructions that, when executed by one or more processors, configure a computing device to perform actions comprising: obtaining a time-series of electrical-consumption data of a service site over a time-range; converting the time-series of electrical-consumption data into a time-series of consumption-change data; associating temperature data with terms of the time-series of consumption-change data to thereby create input data over the time-range; providing the input data over the time-range to a machine-learned model; processing the input data over the time-range in the machine-learned model to generate output, wherein the output comprises a likelihood value of at least one EV charging event during the time-range; and receiving output from the machine-learned model.

18. One or more computer-readable media of clause 17, wherein processing the input data over the time-range in the machine-learned model comprises: recognizing a change in consumption between two terms in the time-series of consumption-change data, wherein the change in consumption is greater than a threshold value.

19. One or more computer-readable media of clause 17, wherein the machine-learned model comprises a convolutional neural network (CNN), and wherein processing the input data over the time-range in the neural network comprises: determining weights to associate with terms in the time-series of consumption-change data; and using the weights associated with a plurality of terms to derive the output from the neural network.

20. One or more computer-readable media of clause 17, wherein the machine-learned model comprises a convolutional neural network, and wherein the CNN is trained on input comprising: labeled data based on EV charging events; and labeled data based on HVAC operational events.

21. One or more computer-readable media of clause 17, additionally comprising: determining a change in temperature data coincident with terms in the time-series of consumption-change data indicating an increase in electricity consumption; and distinguishing the change in consumption from an EV charging event.

22. One or more computer-readable media of clause 17, additionally comprising, responsive to detection of an EV charging event performing at least one of: changing a transformer used by the service site; or changing a number of service sites served by the transformer.

23. One or more computer-readable media of clause 17, additionally comprising one or more or all of any of the preceding clauses.

### Example of Midnight Outlier Usage Model Systems and Devices

The disclosure describes three complimentary, synergistically interacting, and yet individually capable techniques for detecting electrical vehicle charging activities. In an example of the “midnight outlier usage model,” a time-series of electricity consumption values at a service site is obtained. First outlier usage events are identified, having consumption greater than most values of the time-series. From among the first outlier usage events, second outlier usage events having volatility that is less than a second threshold value are identified. From among the second outlier usage events, third outlier usage events lasting a third threshold period of time or longer are identified. A time of day during which each of the third outlier usage events occur is calculated. From among the third outlier usage events, fourth outlier usage events having a time of day that is within off-peak hours are identified. The fourth outlier usage events are flagged as exhibiting EV charging behavior.

The following examples of “a midnight outlier usage model” are expressed as numbered clauses. While the examples illustrate a number of possible configurations and techniques, they are not meant to be an exhaustive listing of the systems, methods, and/or techniques described herein.

1. A method of detecting electric vehicle (EV) charging, comprising: reading data comprising a time-range of a time-series of electricity consumption values at a service site; identifying first outlier usage events, wherein the first outlier usage events have respective rates of consumption that are more than a first threshold value greater than a mean usage value of the time-series of electricity consumption values; identifying, from among the first outlier usage events, second outlier usage events having volatility that is less than a second threshold value; identifying, from among the second outlier usage events, third outlier usage events lasting a third threshold period of time or longer; calculating, based on the data, a time of day during which each of the third outlier usage events occur; identifying, from among the third outlier usage events, fourth outlier usage events having a time of day that is within off-peak hours; and flagging the fourth outlier usage events as exhibiting EV charging behavior.

2. The method of clause 1, additionally comprising: calculating terms in the time-series of changes in electricity consumption values to be differences between adjacent terms of the time-series of electricity consumption values.

3. The method of clause 1, wherein identifying the first outlier usage events comprises: identifying first outlier usage events, wherein the first outlier usage events have respective rates of consumption that are at least 3 standard deviations away from a mean usage value of the time-series of electricity consumption values.

4. The method of clause 1, wherein identifying the second outlier usage events comprises: identifying, from among the first outlier usage events, second outlier usage events having volatility that is less than 2 standard deviations away from an average change in the time-series of changes in electricity consumption values.

5. The method of clause 1, wherein identifying third outlier usage events comprises: identifying, from among the second outlier usage events, third outlier usage events lasting one hour or more.

6. The method of clause 1, additionally comprising: aggregating the fourth outlier usage events over a fourth threshold period of time, thereby creating an aggregated value; and identifying the service site as being an EV charging site if the aggregated value exceeds a fifth threshold value.

7. The method of clause 6, wherein aggregating the fourth outlier usage events over the third threshold period of time, comprises: aggregating the fourth outlier usage events over a one-year period.

8. The method of clause 6, wherein the fifth threshold value comprises defaults to 9.

9. The method of clause 1, additionally comprising one or more or all of any of the preceding clauses.

10. A computing device to detect electric vehicle (EV) charging events, wherein the computing device comprises: a processor; and a memory device, in communication with the processor, wherein the memory device comprises statements executed by the processor to perform actions comprising: reading data comprising a time-range of a time-series of electricity consumption values at a service site; identifying first outlier usage events, wherein the first outlier usage events have respective rates of consumption that are more than a first threshold value greater than a mean usage value of the time-series of electricity consumption values; identifying, from among the first outlier usage events, second outlier usage events having volatility that is less than a second threshold value; identifying, from among the second outlier usage events, third outlier usage events lasting a third threshold period of time or longer; calculating, based on the data, a time of day during which each of the third outlier usage events occur; identifying, from among the third outlier usage events, fourth outlier usage events having a time of day that is within off-peak hours; and flagging the fourth outlier usage events as exhibiting EV charging behavior.

11. The computing device of clause 10, wherein identifying the first outlier usage events comprises: identifying first outlier usage events, wherein the first outlier usage events have respective rates of consumption that are at least 3 standard deviations away from a mean usage value of the time-series of electricity consumption values.

12. The computing device of clause 10, wherein identifying the second outlier usage events comprises: identifying, from among the first outlier usage events, second outlier usage events having volatility that is less than 2 standard deviations away from an average change in the time-series of changes in electricity consumption values.

13. The computing device of clause 10, wherein identifying third outlier usage events comprises: identifying, from among the second outlier usage events, third outlier usage events lasting one hour or more.

14. The computing device of clause 10, additionally comprising:
aggregating the fourth outlier usage events over a fourth threshold period of time, thereby creating an aggregated value; and identifying the service site as being an EV charging site if the aggregated value exceeds a fifth threshold value.

15. The computing device of clause 14, wherein aggregating the fourth outlier usage events over the third threshold period of time, comprises: aggregating the fourth outlier usage events over a one-year period.

16. The computing device of clause 14, wherein the fifth threshold value defaults to 9.

17. The computing device of clause 10, additionally comprising one or more or all of any of the preceding clauses.

18. One or more non-transitory computer-readable media storing computer-executable instructions that, when executed by one or more processors, configure a computing device to perform acts comprising: reading data comprising a time-range of a time-series of electricity consumption values at a service site; identifying first outlier usage events, wherein the first outlier usage events have respective rates of consumption that are more than a first threshold value greater than a mean usage value of the time-series of electricity consumption values; identifying, from among the first outlier usage events, second outlier usage events having volatility that is less than a second threshold value; identifying, from among the second outlier usage events, third outlier usage events lasting a third threshold period of time or longer; calculating, based on the data, a time of day during which each of the third outlier usage events occur; identifying, from among the third outlier usage events, fourth outlier usage events having a time of day that is within off-peak hours; and flagging the fourth outlier usage events as exhibiting EV charging behavior.

19. One or more computer-readable media of clause 18, wherein identifying the first outlier usage events comprises: identifying first outlier usage events, wherein the first outlier usage events have respective rates of consumption that are at least 3 standard deviations away from a mean usage value of the time-series of electricity consumption values.

20. One or more computer-readable media of clause 18, wherein identifying the second outlier usage events comprises: identifying, from among the first outlier usage events, second outlier usage events having volatility that is less than 2 standard deviations away from an average change in the time-series of changes in electricity consumption values.

21. One or more computer-readable media of clause 18, wherein identifying third outlier usage events comprises: identifying, from among the second outlier usage events, third outlier usage events lasting one hour or more.

22. One or more computer-readable media of clause 18, additionally comprising: aggregating the fourth outlier usage events over a fourth threshold period of time, thereby creating an aggregated value; and identifying the service site as being an EV charging site if the aggregated value exceeds a fifth threshold value.

23. The computing device of clause 18, additionally comprising one or more or all of any of the preceding clauses.

### Example of Monolith Shape Model Systems and Devices

The disclosure describes three complimentary, synergistically interacting, and yet individually capable techniques for detecting electrical vehicle charging activities. In an example of the “monolith shape model,” it is determining that a consumption increase at a metering device is greater than a first threshold value. It is determined that the consumption is maintained at the metering device without a decrease greater than a second threshold value for a third threshold period of time. It is determined that a consumption decrease at the metering device is greater than a fourth threshold value, wherein the consumption decrease occurs after conclusion of the third threshold period of time. Energy consumption is calculated, based on factors including a magnitude of the consumption increase and a duration of time between the consumption increase and the consumption decrease. It is determined that the energy consumption exceeds a fifth threshold value. Accordingly, the energy consumption is flagged as an EV charging event.

The following examples of a “monolith shape model” are expressed as numbered clauses. While the examples illustrate a number of possible configurations and techniques, they are not meant to be an exhaustive listing of the systems, methods, and/or techniques described herein.

1. A method, comprising: determining that a consumption increase at a metering device is greater than a first threshold value; determining that consumption is maintained at the metering device without a decrease greater than a second threshold value for a third threshold period of time; determining that a consumption decrease at the metering device is greater than a fourth threshold value, wherein the consumption decrease occurs after conclusion of the third threshold period of time; calculating energy consumption, based on factors comprising: a magnitude of the consumption increase; and a duration of time between the consumption increase and the consumption decrease; determining that the energy consumption exceeds a fifth threshold value; and flagging the energy consumption as an EV charging event.

2. The method of clause 1, wherein the first threshold value comprises 1.5 kWh over a half-hour period.

3. The method of clause 1, wherein the third threshold period of time comprises 60 minutes.

4. The method of clause 1, wherein the fourth threshold value comprises 1.5 kWh over a half hour period.

5. The method of clause 1, wherein the fifth threshold value comprises 6 to 8 kWh per week.

6. The method of clause 1, additionally comprising: flagging a week having more than a sixth threshold number of EV charging events; flagging a year having more than a seventh threshold number of flagged weeks; and flagging a service site of the EV charging events as charging an EV vehicle.

7. The method of clause 1, wherein: determining that the consumption increase at the metering device is greater than the first threshold value comprises determining that a first term in a time-series of consumption changes indicates an increase in consumption of the first threshold value or more; and determining that the consumption decrease at the metering device is greater than the fourth threshold value comprises determining that a second term in the time-series of consumption changes indicates a decrease in consumption of the fourth threshold value or more.

8. The method of clause 1, additionally comprising one or more or all of any of the preceding clauses.

9. A computing device, comprising: a processor, and a memory device, in communication with the processor, wherein the memory device comprises statements executed by the processor to perform actions comprising: determining that a consumption increase at a metrology unit is greater than a first threshold value; determining that consumption is maintained at the metrology unit without a decrease greater than a second threshold value for a third threshold period of time; determining that a consumption decrease at the metrology unit is greater than a fourth threshold value, wherein the consumption decrease occurs after conclusion of the third threshold period of time; calculating energy consumption, based on factors comprising: a magnitude of the consumption increase; and a duration of time between the consumption increase and the consumption decrease; determining that the energy consumption exceeds a fifth threshold value; and flagging the energy consumption as an EV charging event.

10. The computing device of clause 9, wherein the first threshold value comprises 1.5 kWh over a half hour period.

11. The computing device of clause 9, wherein the third threshold period of time comprises 60 minutes.

12. The computing device of clause 9, wherein the fourth threshold value comprises 1.5 kWh over a half hour period.

13. The computing device of clause 9, wherein the fifth threshold value comprises 6 to 8 kWh per week.

14. The computing device of clause 9, wherein flagging the energy consumption comprises: flagging a period of time after the consumption increase and before the consumption decrease as the EV charging event.

15. The computing device of clause 9, wherein: determining that the consumption increase at the metrology unit is greater than the first threshold value comprises determining that a first term in a time-series of consumption changes indicates an increase in consumption of the first threshold value or more; and determining that the consumption decrease at the metrology unit is greater than the fourth threshold value comprises determining that a second term in the time-series of consumption changes indicates a decrease in consumption of the fourth threshold value or more.

16. The computing device of clause 9, additionally comprising one or more or all of any of the preceding clauses.

17. One or more computer-readable media storing computer-executable instructions that, when executed by one or more processors, configure a computing device to perform acts comprising: determining that a consumption increase at a metering device is greater than a first threshold value; determining that consumption is maintained at the metering device without a decrease greater than a second threshold value for a third threshold period of time; determining that a consumption decrease at the metering device is greater than a fourth threshold value, wherein the consumption decrease occurs after conclusion of the third threshold period of time; calculating energy consumption, based on factors comprising: a magnitude of the consumption increase; and a duration of time between the consumption increase and the consumption decrease; determining that the energy consumption exceeds a fifth threshold value; and flagging the energy consumption as an EV charging event.

18. One or more computer-readable media of clause 17, wherein the first threshold value comprises 1.5 kWh over a half hour period.

19. One or more computer-readable media of clause 17, wherein the third threshold period of time comprises a value between 30 and 90 minutes.

20. One or more computer-readable media of clause 17, wherein the fourth threshold value comprises 1.5 kWh over a half hour period.

21. One or more computer-readable media of clause 17, wherein flagging the energy consumption comprises: flagging a period of time after the consumption increase and before the consumption decrease as the EV charging event.

22. One or more computer-readable media of clause 17, wherein: determining that the consumption increase at the metering device is greater than the first threshold value comprises determining that a first term in a time-series of consumption changes indicates an increase in consumption of the first threshold value or more; and determining that the consumption decrease at the metering device is greater than the fourth threshold value comprises determining that a second term in the time-series of consumption changes indicates a decrease in consumption of the fourth threshold value or more.

23. One or more computer-readable media of clause 15, additionally comprising one or more or all of any of the preceding clauses.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

The words comprise, comprises, and/or comprising, when used in this specification and/or claims specify the presence of stated features, devices, techniques, and/or components. The words do not preclude the presence or addition of one or more other features, devices, techniques, and/or components and/or groups thereof.

1. A method of detecting electric vehicle (EV) charging, comprising:
obtaining a time-series of electrical-consumption data of a service site over a time-range;
converting the time-series of electrical-consumption data into a time-series of consumption-change data;
associating temperature data with terms of the time-series of consumption-change data to thereby create input data over the time-range;
providing the input data over the time-range to a machine-learned model;
processing the input data over the time-range in the machine-learned model to generate output, wherein the output comprises a likelihood value of at least one EV charging event during the time-range; and
receiving output from the machine-learned model.

2. The method of claim 1, wherein processing the input data over the time-range in the machine-learned model comprises:
recognizing a change in consumption between two terms in the time-series of consumption-change data, wherein the change in consumption is greater than a threshold value.

3. The method of claim 1, wherein the machine-learned model comprises a convolutional neural network (CNN), and wherein processing the input data over the time-range in the CNN comprises:
determining weights to associate with terms in the time-series of consumption-change data; and
using the weights associated with a plurality of terms to derive the output from the CNN.

4. The method of claim 1, wherein the machine-learned model comprises a convolutional neural network (CNN), and wherein the CNN is trained on input comprising:
labeled data based on EV charging events; and
labeled data based on HVAC operational events.

5. The method of claim 1, additionally comprising:
determining a change in temperature data coincident with terms in the time-series of consumption-change data indicating an increase in electricity consumption; and
distinguishing the change in consumption from an EV charging event.

6. The method of claim 1, additionally comprising, responsive to detection of an EV charging event performing at least one of:
changing a transformer used by the service site;
changing a number of service sites served by the transformer; or
changing a phase of electricity provided to the transformer.

7. The method of claim 1, wherein:
the likelihood value comprises a value from 0.0 to 1.0; and
the time-range is one week.

8. A computing device to detect electric vehicle (EV) charging events, wherein the computing device comprises:
a processor; and
a memory device, in communication with the processor, wherein the memory device comprises statements executed by the processor to perform actions comprising:
obtaining a time-series of electrical-consumption data of a service site over a time-range;
converting the time-series of electrical-consumption data into a time-series of consumption-change data;
associating temperature data with terms of the time-series of consumption-change data to thereby create input data over the time-range;
providing the input data over the time-range to a subroutine configured to detect EV charging incidents, wherein the subroutine performs actions comprising:
identifying load-changes within the time-range, wherein the load-changes are of a magnitude to indicate EV charging; and
filtering the load-changes to remove load-changes coincident with temperature changes; and
responsive to the subroutine recognizing one or more possible EV charging incidents, determining a likelihood of at least one EV charging event during the time-range based at least in part on the one or more possible EV charging events.

9. The computing device of claim 8, wherein identifying load-changes within the time-range by the subroutine comprises:
recognizing a change in consumption between two terms in the time-series of consumption-change data, wherein the change in consumption is 3 kWh or more.

10. The computing device of claim 8, wherein the subroutine comprises a convolutional neural network (CNN), and wherein the subroutine performs additional actions comprising:
determining weights to associate with terms in the time-series of consumption-change data; and
using the weights associated with a plurality of terms to derive an output from the CNN.

11. The computing device of claim 8, wherein the subroutine comprises a convolutional neural network (CNN), and wherein the CNN is trained on input comprising:
labeled data based on EV charging events; and
labeled data based on HVAC operational events.

12. The computing device of claim 8, additionally comprising:
determining a change in temperature data coincident with terms in the time-series of consumption-change data indicating an increase in electricity consumption; and
distinguishing the change in consumption from an EV charging event.

13. The computing device of claim 8, based at least in part on the likelihood of the at least one EV charging event, performing at least one of:
changing a transformer used by the service site; or
changing a number of service sites served by the transformer.

14. The computing device of claim 8, wherein:
the likelihood comprises a value from 0.0 to 1.0; and
the time-range is one week.

15. One or more non-transitory computer-readable media storing computer-executable instructions that, when executed by one or more processors, configure a computing device to perform actions comprising:
obtaining a time-series of electrical-consumption data of a service site over a time-range;
converting the time-series of electrical-consumption data into a time-series of consumption-change data;
associating temperature data with terms of the time-series of consumption-change data to thereby create input data over the time-range;
providing the input data over the time-range to a machine-learned model;
processing the input data over the time-range in the machine-learned model to generate output, wherein the output comprises a likelihood value of at least one EV charging event during the time-range; and
receiving output from the machine-learned model.

16. One or more computer-readable media of claim 15, wherein processing the input data over the time-range in the machine-learned model comprises:
recognizing a change in consumption between two terms in the time-series of consumption-change data, wherein the change in consumption is greater than a threshold value.

17. One or more computer-readable media of claim 15, wherein the machine-learned model comprises a convolutional neural network (CNN), and wherein processing the input data over the time-range in the CNN comprises:
determining weights to associate with terms in the time-series of consumption-change data; and
using the weights associated with a plurality of terms to derive the output.

18. One or more computer-readable media of claim 15, wherein the machine-learned model comprises a convolutional neural network (CNN), and wherein the CNN is trained on input comprising:
labeled data based on EV charging events; and
labeled data based on HVAC operational events.

19. One or more computer-readable media of claim 15, additionally comprising:
determining a change in temperature data coincident with terms in the time-series of consumption-change data indicating an increase in electricity consumption; and
distinguishing the change in consumption from an EV charging event.

20. One or more computer-readable media of claim 15, additionally comprising, responsive to detection of an EV charging event performing at least one of:
changing a transformer used by the service site; or
changing a number of service sites served by the transformer.
